(19) United States
(12) Patent Application Publication
(10) Pub. No.: US 2006/0225088 A1
(43) Pub. Date: Oct. 5, 2006

(54) Generation of implicit tv recommender via shows image content

(75) Inventor: Srinivas Venkata Rama Gutta, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/552,804

(22) PCT Filed: Apr. 2, 2004
(86) PCT No.: PCT/IB04/01140

§ 371 Date: Oct. 11, 2005

Related U.S. Application Data
(60) Provisional application No. 60/462,778, filed on Apr. 14, 2003.

(51) Int. Cl. H04H 9/00

(52) U.S. Cl. 725/14; 725/32

(57) ABSTRACT

A system and method for providing recommendation according to the preferences of the user based on the user's past viewing history. The system keeps track of the program image contents watched by a user to generate a user's preference. Then, a plurality of recommendations based on the viewer's viewing habit stored in the user profile is offered to the user, so that the user can selectively watch the programs of his or her interest.

The present invention relates to a system and method for recommending television programming and, more particular, to a system and method for providing a particular programming of interest based on an image recommendation made from the customer's preference or profile.

The modern world with huge amounts of multimedia gives television viewers a tremendous variety and range of options. Currently, there are over 500 different program channels shown through a cable television service. As the number of channels available to television viewers has increased, along with the diversity of programming content available on such channels, it has become increasingly challenging for television viewers to identify television programs or retrieve information of their interests.

There are different types of television program guides that are available, i.e., the electronic program guides (EPGs), which allow television viewers to sort or search the available television programs in accordance with personalized preferences. The EPGs allow viewers to identify desirable programs more efficiently than conventional printed guides. As many viewers have a particular preference for or bias against certain categories of programming, such as the viewer's preferences, can be applied to the EPG to obtain a set of recommended programs that may be of interest to a particular viewer.

These TV show recommenders help users better manage the tremendous number of choices. However, users do not always trust that these recommenders work well or that they even have the user's best intentions in mind. Accordingly, the present invention provides a novel way of increasing trust in a recommender by having it presenting itself as being “on the same side” as the user and by reminding the user of a related show or event observed by both the user and the recommender in the past.

The present invention is directed to a method and system for providing content recommendations according to the past viewing history of a particular topic.

According to one aspect of the invention, a method of providing a recommendation includes the steps of: receiving a plurality of programs from a plurality of channels; extracting key frames and content of the programs watched by a user to determine preferences of the user; generating a user profile based on the extracted key frames and content of the programs; and, providing a plurality of viewing recommendations based on the user profile. The key frames of a particular program is performed interactively in response to the user's input, and the content of the user profile is updated to reflect said user's changing preference.

According to another aspect of the invention, a method of providing a recommendation includes the steps of: generating at least one user profile indicating preferences of a user for a particular program based on the video image contents and its electronic program guide (EPG) data embedded therein; comparing the user profile with incoming programs from a plurality of channels to determine a desired program; and, if there is match, recommending the desired program to the viewer.

According to another aspect of the invention, a system of providing a recommendation includes an input device for providing viewing preference of a user; and a processor for: receiving a plurality of programs from a plurality of channels; extracting key frames and content of the programs watched by a user to determine preferences of the user; generating a user profile based on the extracted key frames and content of the programs; and, providing a plurality of viewing recommendations based on the user profile.

According to yet another aspect of the invention, a system of providing a recommendation includes an input device for providing viewing preference of a user, and a processor for: generating at least one user profile indicating preferences of a user for a particular program based on video image contents and its electronic program guide (EPG) data embedded therein; comparing the user profile with incoming programs from a plurality of channels to determine a desired program; and, if there is match, recommending the desired program to the viewer.

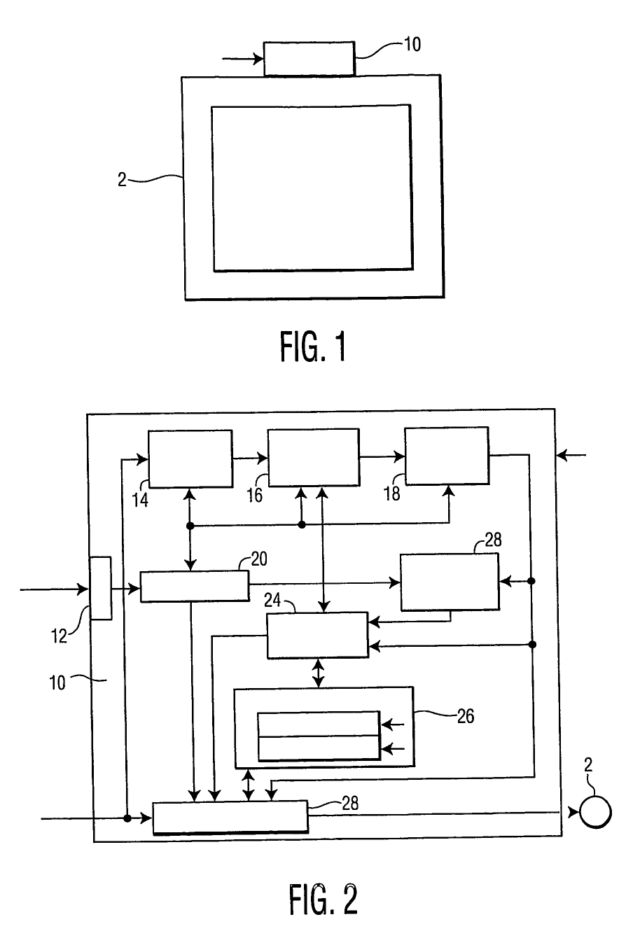

FIG. 1 illustrates a simplified block diagram of the system according to an embodiment of the present invention.

FIG. 2 shows major components of the system according to an embodiment of the present invention.

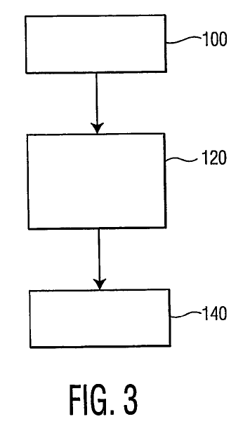

FIG. 3 is a flow chart illustrating a user profile development session in accordance with the present invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention with unnecessary detail.

FIG. 1 shows a conventional television system 2 and a receiver 10 whereto the preferred embodiments of the present invention may be applied. The receiver 10 may also include other personal recording devices, such as ReplayTV (trademark of REPLAY NETWORKS, INC., of Palo Alto, Calif.) and TiVo (trademark of TIVO, Inc., of Sunnyvale, Calif.), that give the television viewer new abilities to capture and manipulate the stream of television shows, which flow from their cable and satellite systems.

As shown in FIG. 1, the receiver 10 is configured to receive audio and video programming from the conventional television (TV) broadcast as well as other variety of sources, including a cable service provider, digital high definition television (HDTV) and/or digital standard definition television (SDTV) signals, a satellite dish, a conventional RF broadcast, an Internet connection, or another storage device, such as a VHS player or DVD player. The audio and video programming can be delivered in analog, digital, or digitally compressed formats via any transmission means, including satellite, cable, wire, television broadcast, or sent via the Web. It should be noted that the present system is also capable of being connected to other possible networks, such as a direct private network and a wireless network.

According to the teachings of the present invention, viewers can be recommended with shows of their interest the receiver 10 based on the past viewing history, preference, or user profile. To achieve this, the receiver 10 detects incoming television programs from a plurality of different channels and maintains a database containing the viewing history of a particular viewer based on the show's video images and/or any optional EPG-related information, then determines the type of TV programs that are watched or not watched by the viewer. Note that receiver 10 may comprise a separate channel can be dedicated to receive the electronic program guide (EPG) data from a different source. Thereafter, a recommendation as to the type of programs or channels that the viewer likes to watch is generated according to the past viewing history.

Now, a detailed description of the present invention will be explained hereinafter.

FIG. 2 illustrates an exemplary receiver 10 in greater detail according to the embodiment of the present invention. The receiver 10 includes an input interface (i.e., IR sensor) 12, MPEG-2 encoder 14, hard disk drive 16, MPEG-2 decoder 18, controller 20, feature extractor 22, video processor 24, memory 26, and playback section 28. It should be noted that the MPEG encoder/decoder may comply with other MPEG standards, i.e., MPEG-1, MPEG-2, MPEG-4, and MPEG-7. The controller 20 oversees the overall operation of the receiver 10, including a feature extraction mode, record mode, play mode, and other modes that are common in a typical receiving device. It should be noted that the receiver 10 may be embodied in the television system 2.

During a normal mode, the controller 20 causes the incoming television signals to be demodulated and processed by the video processor 24 and transmits them to the television set 2 for display. Then, the video processor 24 converts the incoming TV signals to the corresponding baseband television signals that are suitable for display on the television set 2.

During a recording mode, the controller 20 causes the MPEG-2 encoder 14 to receive incoming television signals delivered from satellite, cable, wire, and television broadcasts or the web and converts the received TV signals to the MPEG format for storage on the hard disk driver 16. Thereafter, the controller 20 causes the hard disk driver 16 to stream the stored television signals to the MPEG-2 decoder, which in turn transmits the decoded TV signals to be transmitted to the television set 2 via the play back section 28 for display.

During a feature extraction mode, the feature extractor 22 operates to process and generate data that is representative of the viewing history of a given user to determine the type of programs most watched by the viewer, then generates the user's viewing habits to build a user profile in the memory 26. Alternatively, the viewer may explicitly designate the type of shows or programs he or she prefers when generating the user profile.

To build the user profile, video information is input to a feature extractor 22 where the content of the video information is analyzed according to the type of (1) show image content and (2) a pre-set classification. A well-known electronic program guide (EPG) protocol may be utilized for the provision of a pre-set classification. An EPG is a standard application designed to aid the viewer in the navigation of and selection from a broadcast material available in a TV environment. The EPG provides information about each program and includes programming characteristics, such as the channel number, program title, start time, end time, elapsed time, time remaining, rating (if available), topic, theme, and a brief description of the program's content. Using the EPG features, the feature extractor 22 classifies the incoming programs into one of the pre-set categories, i.e., sports, old classic movies, action movies, etc.

In addition to the EPG features, video images are analyzed according to the embodiment of the present invention to learn and recognize the shows of interest for a particular viewer by evaluating the visual data characteristics, including color, texture, objects, object motion, and scenes, etc. It is noted that EPG features do not ways provide enough data for a subsequent recommendation of type of exact show of viewer's interest.

Accordingly, the feature extractor 22, upon receiving incoming video signals, extracts keyframes (thumbnail images or the like). This input can be used as the preferred categories of the user along with the EPG information.

Note that detecting keyframes according to the content of the video information is well known in the art that can be performed in a variety of ways. See for example, Video and image processing in multimedia system, by Borko Furht, Stephen W. Smoliar, and Hongjiang Zhang, Kluwer Academia Publishers, 1995, the content of which is hereby incorporated by reference. Briefly, a video sequence comprised of a number of camera shots or scene changes go under a detection of scene changes for extracting key frames. One approach of detecting key frames is based on a histogram comparison approach, in which a comparison of corresponding pixels or regions in successive frames is performed to generate a histogram of intensity levels. Each histogram for a frame is compared to a histogram with a next frame since histogram varies from one video source to another. Then, a threshold is selected to determine whether a pixel or region has changed across successive frames. The key frame that exceeds threshold is selected as the key frame. This process is repeated for all the frames in the scene and for each scene change. Finally, the key frames from each scene change is collated and divided into blocks, and then features, such as mean, standard deviation, entropy, and dominant colors are extracted. In an alternate embodiment, viewers can specify the beginning and ending segment of a video sequence to go under the feature extraction process, or can provide specific camera shots or key frames via the input interface 12 of the receiver 10.

The video features extracted by the feature extractor 22 as described above, combined with the EPG information are provided to the memory 26 to configure the types of video program shows of the viewer's interest. The content of extracted video key frames and key frames from the feature extractor 22 are provided to the user profile of the memory 16 to build a personal viewing preference. This viewing preference to particular programs is then used to recommend the viewer during a subsequent viewing mode. In this regard, well-understood leaning paradigms, such as Hidden Markov Models (HMMs), Bayesian networks, genetic algorithms, and neural networks, can be employed to create a user profile. For example, U.S. patent application Ser. No. 09/466,406 filed on Dec. 17, 1999 by the inventor of this application, entitled “method and Apparatus for Recommending Television Programming using Decision Trees”, the content of which is hereby incorporated by reference.

Note that other learning models, or combinations thereof apparent to one of ordinary skill in the art, may be used as well.

FIG. 3 shows user profile development steps according to the embodiment of the present invention. The receiver 10 observes the user's viewing habits over time (step 100), during which each incoming video program is classified as described above (step 120). Here, the user's viewing preference, including the type of shows most frequently watched, and this information is used to build a user profile in the memory 26. Thereafter, the user profile is updated (step 140). Accordingly, a database reflecting the user's likes or dislikes of various shows can be obtained based on the user's viewing pattern, such that the receiver 10 can later recommend a list of programs that the viewer prefer based on the past viewing history.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

1. A method for providing a recommendation, the method comprising the steps of:
receiving a plurality of programs from a plurality of channels;
extracting key frames and content of said plurality of programs watched by a user to determine preferences of said user;
generating a user profile based on said extracted key frames and content of said plurality of programs; and,
providing a plurality of viewing recommendations based on said user profile.

2. The method of claim 1, further comprising the step of selecting at least one viewing recommendation by said user.

3. The method of claim 1, further comprising the step of displaying at least one viewing recommendation.

4. The method of claim 1, wherein the step of extracting the key frames of a particular program is performed interactively in response to said user's input.

5. The method of claim 1, further comprising the step of updating the content of said user profile to reflect said user's changing preference.

6. The method of claim 1, wherein the step of extracting the content of said plurality of programs is performed according to an electronic program guide (EPG) data.

7. A method for providing a recommendation, the method comprising the steps of:
generating at least one user profile indicating preferences of a user for a particular program based on video image contents and its electronic program guide (EPG) data embedded therein;
comparing said user profile with incoming programs from a plurality of channels to determine a desired program; and,
if there is match, recommending said desired program to said viewer.

8. The method of claim 7, further comprising the step of selecting at least one desired program for viewing at a particular time.

9. The method of claim 8, further comprising the step of storing said selected program in a storage medium for a subsequent replay.

10. The method of claim 8, wherein said step of the selection of said desired program is performed interactively in response to said user's input.

11. The method of claim 7, further comprising the step of displaying said desired program for viewing.

12. The method of claim 7, further comprising the step of updating the content of said at least one user profile to reflect said user's changing preference.

13. A system for providing a recommendation, comprising:
an input device for providing viewing preference of a user; and
a processor for:
receiving a plurality of programs from a plurality of channels;
extracting key frames and content of said plurality of programs watched by a user to determine preferences of said user;
generating a user profile based on said extracted key frames and content of said plurality of programs; and,
providing a plurality of viewing recommendations based on said user profile.

14. The system of claim 13, further comprising a memory for storing the preferences of said user.

15. The system of claim 13, wherein the processor is further operative to update the content of said user profile to reflect said user's changing preference.

16. A system for providing a recommendation, comprising:
an input device for providing viewing preference of a user; and
a processor for:
generating at least one user profile indicating preferences of a user for a particular program based on video image contents and its electronic program guide (EPG) data embedded therein;
comparing said user profile with incoming programs from a plurality of channels to determine a desired program; and,
if there is match, recommending said desired program to said viewer.

17. The system of claim 16, further comprising a memory for storing said at least one user profile.

18. The system of claim 16, further comprising a display for displaying said desired program for viewing.

19. The system of claim 16, wherein the processor is further operative to update the content of said user profile to reflect said user's changing preference.
